(19) United States
(12) Patent Application Publication
(10) Pub. No.: US 2026/0363428 A1
(43) Pub. Date: Nov. 19, 2026

(54) INTERDENTAL BRUSH HAVING OBSERVATION FUNCTION

(71) Applicant: Yixuan Brand Management (Jiangsu) Co., Ltd, Changzhou (CN)

(72) Inventors: Yuying YIN, Changzhou (CN); Yufang TAO, Changzhou (CN); Zhangchun ZHANG, Shangrao (CN)

(73) Assignee: Yixuan Brand Management (Jiangsu) Co., Ltd, Changzhou (CN)

(21) Appl. No.: 19/720,985

(22) Filed: Jun. 26, 2026

Related U.S. Application Data
(63) Continuation of application No. PCT/CN2024/142629, filed on Dec. 26, 2024.

(30) Foreign Application Priority Data
Dec. 28, 2023 (CN) 202311832262.X

(51) Int. Cl. A46B 15/00; A46B 5/00; A46B 9/04; A46B 17/08; H04N 7/18; H04N 23/50

(52) U.S. Cl. CPC A46B 15/0006; A46B 5/0095; A46B 9/045; A46B 15/0036; A46B 17/08; H04N 7/183; H04N 23/555; A46B 2200/108

(57) ABSTRACT

An interdental brush with an observation function includes two brush bodies, a brush head detachably mounted at an end of a brush body, and a camera, a switch, a motherboard, a wireless transceiver module, and a battery inside the bodies. The camera's image acquisition end is adjacent the brush head. The motherboard is electrically connected to the camera, switch, wireless transceiver module, and battery. The camera sends acquired images via the wireless transceiver module to a terminal with a display screen, allowing a user to observe a to-be-cleaned portion in an oral cavity in real time to facilitate interdental cleaning. The internal assemblies are separately mounted in the two brush bodies for easy processing and assembly, and the assemblies in the two bodies are electrically connected via two contacts for convenient circuit detection.

### RELATED APPLICATIONS

The present patent document is a continuation of PCT/CN2024/142629, filed 26 Dec. 2024, which claims the benefit of priority to Chinese Patent Application No. 202311832262.X, filed 28 Dec. 2023, and entitled “TOOTH GAP BRUSH HAVING OBSERVATION FUNCTION” the entire contents of each of which are incorporated herein by reference.

### TECHNICAL FIELD

The present invention belongs to the technical field of interdental brushes, and specifically, to an interdental brush having an observation function.

### BACKGROUND

Similar to a common toothbrush, an interdental brush has two parts: a brush head part and a brush handle part. The biggest difference lies only in designs of brush heads. Using an interdental brush to remove food debris in a tooth gap is beneficial for people to protect their oral hygiene and teeth. In the existing technology, when a person uses an interdental brush, it is difficult to see a tooth gap on a back side with naked eyes. As a result, the tooth gap is missed easily and cannot be cleaned thoroughly.

Therefore, it is urgent to propose an interdental brush having an observation function, which facilitates thorough interdental cleaning.

### SUMMARY

To overcome the defect in the existing technology, the present invention provides an interdental brush having an observation function.

To resolve the above technical problem, the present invention provides the following technical solutions.

The present invention provides an interdental brush having an observation function. The interdental brush includes interdental brush bodies, an interdental brush head, as well as a camera, a switch button, a motherboard, a wireless signal transceiver module, and a battery that are disposed inside the interdental brush bodies, where the interdental brush head is detachably mounted at an end of the interdental brush body; an image acquisition end of the camera is adjacent to the interdental brush head; the motherboard is electrically connected to the camera, the switch button, the wireless signal transceiver module, and the battery; and the camera sends an acquired image through the wireless signal transceiver module to a terminal having a display screen.

Preferably, the interdental brush bodes include a first interdental brush body and a second interdental brush body; the first interdental brush body and the second interdental brush body are detachably connected together into an ivory shape; the first interdental brush body is an arc-shaped tubular structure provided with a first accommodating cavity; a first contact mounting seat is disposed at a front end of the first interdental brush body; a first contact is disposed on the first contact mounting seat; the switch button, the motherboard, the wireless signal transceiver module, and the battery are disposed in the first accommodating cavity; a rear cover is connected to a rear end of the first interdental brush body; and the switch button passes through the rear cover and protrudes from an outer surface at a left end of the rear cover.

The second interdental brush body is an arc-shaped tubular structure provided with a second accommodating cavity; a brush head mounting portion used for mounting of the interdental brush head is disposed at a front end of the second interdental brush body; a mounting and clamping groove is formed in a rear end of the second interdental brush body; a second contact electrically connected to the first contact is disposed in the mounting and clamping groove; a camera mounting hole communicated with the second accommodating cavity is formed in a position that is on a side wall of the second interdental brush body and adjacent to the brush head mounting portion; and the image acquisition end of the camera is disposed in the camera mounting hole.

Preferably, the switch button is electrically connected to the motherboard through a motherboard-switch connecting line; the wireless signal transceiver module is electrically connected onto the motherboard; the first contact is electrically connected to the motherboard through a first contact connecting line; and the second contact is electrically connected to the camera through a camera connecting line.

Preferably, a fill light is connected to a side of the camera.

Preferably, a USB charging interface is disposed on the rear cover; and the USB charging interface is electrically connected to the motherboard.

Preferably, a decorative ring is further provided; and the decorative ring sleeves a joint between the first interdental brush body and the second interdental brush body.

Preferably, a brush head mounting hole is formed inwards in a bottom of the brush head mounting portion; an L-shaped brush head positioning groove is formed in a side wall of the brush head mounting portion; the interdental brush head includes a brush head body and a brush head connector; the brush head connector includes a brush head connecting shaft and a brush head positioning protrusion; the brush head positioning protrusion is integrally disposed on a side wall of the brush head connecting shaft and is clamped on the L-shaped brush head positioning groove; the brush head connecting shaft is matched with the brush head mounting hole; the brush head connecting shaft is clamped in the brush head mounting hole through the brush head positioning protrusion; and the brush head body is coaxially disposed on the brush head connecting shaft.

Preferably, a brush head mounting hole penetrating the brush head mounting portion is formed in the brush head mounting portion; and an elastic clamping and limiting bar and a fixing and limiting protrusion are oppositely disposed on side surfaces of the brush head mounting hole.

Preferably, a base is further provided; a base cover is disposed on the base; a groove used for accommodating the interdental brush bodies is formed in an upper part of the base cover; and a sucking disc is disposed under the base.

Compared with the existing technology, the present invention has the following beneficial effect:

According to the present invention, the camera transmits a shot interdental condition to an external terminal, which helps a user observe a condition of a to-be-cleaned portion in an oral cavity in real time, thereby facilitating interdental cleaning. Internal assemblies are separately mounted in the two interdental brush bodies, so that the assemblies can be processed and mounted conveniently. In addition, the assemblies in the two interdental brush bodies are electrically connected to each other through the two contacts, which facilitates circuit detection.

### BRIEF DESCRIPTION OF DRAWINGS

FIG. 1 is a sectional view of a structure of an interdental brush having an observation function according to Embodiment 1 of the present invention;

FIG. 2 is a schematic diagram of an integral structure according to Embodiment 1 of the present invention;

FIG. 3 is a left side view of Embodiment 1 of the present invention;

FIG. 4 is a schematic diagram of a structure of a brush head mounting portion according to Embodiment 1 of the present invention;

FIG. 5 is a schematic diagram of a structure of an interdental brush head according to Embodiment 1 of the present invention;

FIG. 6 is a schematic diagram of a structure of a base according to Embodiment 1 of the present invention;

FIG. 7 is a schematic diagram of a structure of a brush head mounting portion according to Embodiment 2 of the present invention;

FIG. 8 is a sectional view of a structure of a brush head mounting portion according to Embodiment 2 of the present invention; and

FIG. 9 is a schematic diagram of a structure of an interdental brush head according to Embodiment 2 of the present invention;

### DESCRIPTION OF EMBODIMENTS

The following describes preferred embodiments of the present invention with reference to the accompanying drawings. It should be understood that the preferred embodiments described herein are merely used to describe and explain the present invention, rather than to limit the present invention.

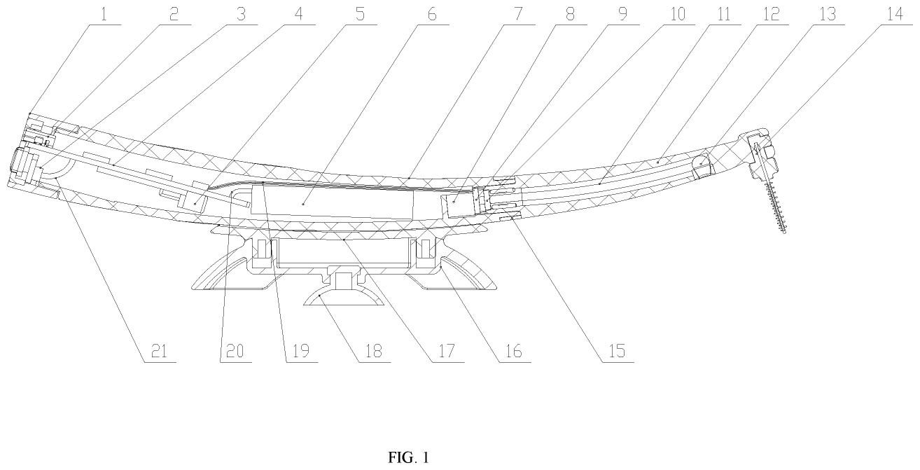

In the description of the present invention, it should be understood that orientations or position relationships indicated by terms “left”, “right”, and the like are orientations or position relationships based on the illustration shown in FIG. 1 of this specification; and these terms are merely used to facilitate description of the present invention and simplify the description, rather than to indicate or imply that the mentioned apparatus or element must have a specific orientation or be constructed and operated in a specific orientation. Therefore, these terms should not be understood as a limitation to the present invention.

In the description of the present invention, it should be noted that, unless otherwise specified and defined explicitly, terms “mounting”, “interconnection” and “connection” should be understood in their broad senses. For example, “connection” may be a fixed connection, a detachable connection or an integrated connection, and may be a direct connection or an indirect connection via an intermediate medium. Those of ordinary skill in the art may understand specific meanings of the above terms in the present invention based on a specific situation.

### Embodiment 1

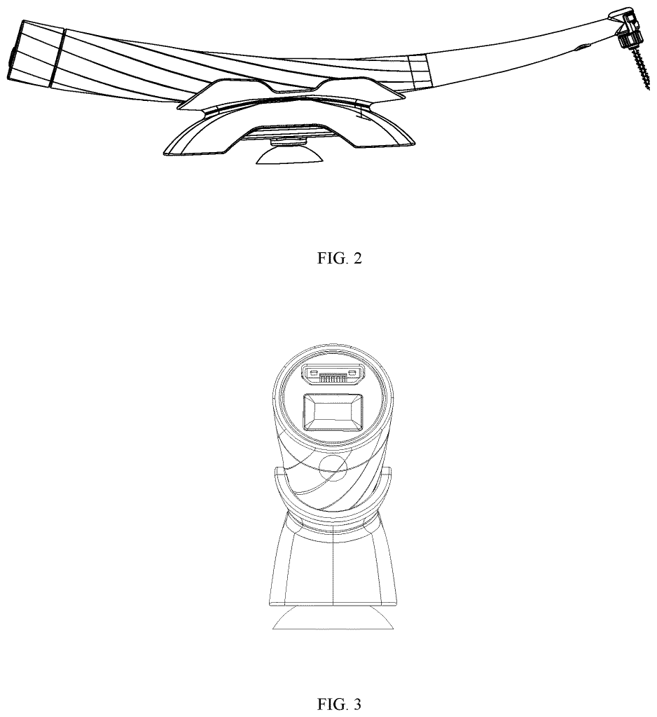

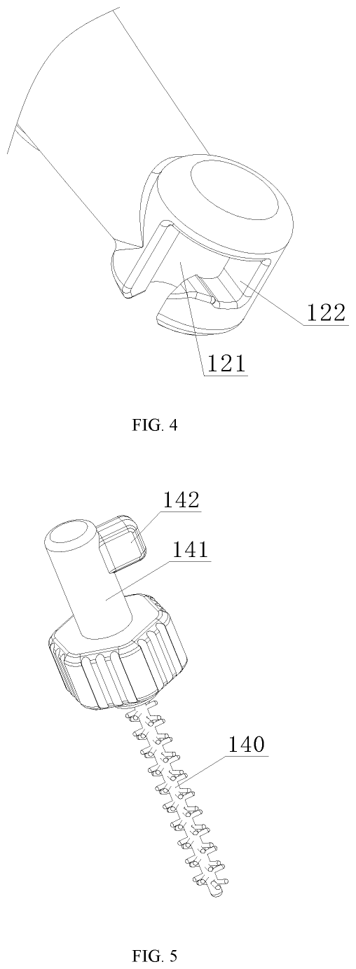

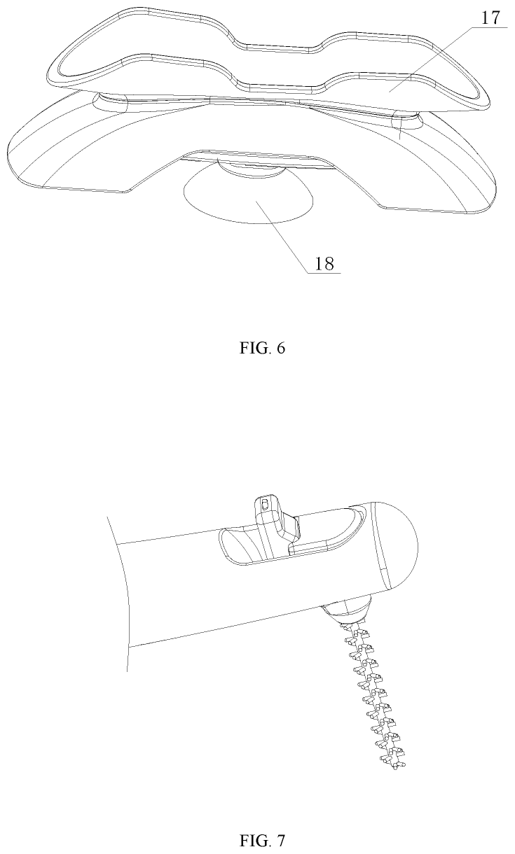

As shown in FIG. 1 to FIG. 6, this embodiment provides an interdental brush having an observation function. The interdental brush includes interdental brush bodies, an interdental brush head 14, as well as a camera 13, a switch button 3, a motherboard 4, a wireless signal transceiver module 5, and a battery 6 that are disposed inside the interdental brush bodies.

In this embodiment, the interdental brush bodes include a first interdental brush body 7 and a second interdental brush body 12; the first interdental brush body 7 is an arc-shaped tubular structure provided with a first accommodating cavity; a first contact mounting seat 8 is disposed at a front end of the first interdental brush body 7; a first contact 9 is disposed on the first contact mounting seat 8; the switch button 3, the motherboard 4, the wireless signal transceiver module 5, and the battery 6 are disposed in the first accommodating cavity; a rear cover 1 is connected to a rear end of the first interdental brush body 7; the switch button 3 passes through the rear cover 1 and protrudes from an outer surface at a left end of the rear cover 1; the second interdental brush body 12 is an arc-shaped tubular structure provided with a second accommodating cavity; a brush head mounting portion used for mounting of the interdental brush head is disposed at a front end of the second interdental brush body 12; a mounting and clamping groove is formed in a rear end of the second interdental brush body 12; a second contact 10 electrically connected to the first contact is disposed in the mounting and clamping groove; a camera mounting hole communicated with the second accommodating cavity is formed in a position that is on a side wall of the second interdental brush body 12 and adjacent to the brush head mounting portion; and an image acquisition end of the camera 13 is disposed in the camera mounting hole.

In this embodiment, the motherboard 4 is electrically connected to the camera 13, the switch button 3, the wireless signal transceiver module 5, and the battery 6; the camera 13 sends an acquired image through the wireless signal transceiver module 5 to a terminal having a display screen; the terminal having the display screen may be a mobile phone, a tablet computer, or a notebook; the switch button 3 is electrically connected to the motherboard 4 through a motherboard-switch connecting line 21; the wireless signal transceiver module 5 is electrically connected onto the motherboard 4; the first contact 9 is electrically connected to the motherboard 4 through a first contact connecting line 19; and the second contact 10 is electrically connected to the camera 13 through a camera connecting line 11.

In this embodiment, a brush head mounting hole 121 is formed inwards in a bottom of the brush head mounting portion; an L-shaped brush head positioning groove 122 is formed in a side wall of the brush head mounting portion; the interdental brush head 14 includes a brush head body 140 and a brush head connector; the brush head connector includes a brush head connecting shaft 141 and a brush head positioning protrusion 142; the brush head body 140 is coaxially disposed on the brush head connecting shaft 141; the brush head positioning protrusion 142 is integrally disposed on a side wall of the brush head connecting shaft 141 and is clamped on the L-shaped brush head positioning groove 122; the brush head connecting shaft 141 is matched with the brush head mounting hole 121; and the brush head connecting shaft 141 is clamped in the brush head mounting hole 121 through the brush head positioning protrusion 142. Therefore, the interdental brush head is detachably mounted on the brush head mounting portion, thereby being convenient to mount and demount. In addition, a circular protrusion is disposed at a position, exposed out of the brush head mounting portion, of the brush head connecting shaft; an outer diameter of the circular protrusion is greater than an outer diameter of the brush head connecting shaft; and strip-shaped bulges or sawteeth may be added to the circular protrusion according to actual requirements, thereby increasing a hand-twisting torque. This can further facilitate operation.

In this embodiment, a fill light is connected to a side of the camera 13. The fill light can directly irradiate light to a tooth gap, so that brightness is high, and the camera is enabled to have high imaging definition. Therefore, convenience is brought to shooting a condition in an oral cavity clearly.

In this embodiment, a USB charging interface 2 is disposed on the rear cover 1; and the USB charging interface 2 is electrically connected to the motherboard 4, so that the motherboard 4 can be charged through the USB charging interface.

In this embodiment, a decorative ring 15 is further provided; and the decorative ring 15 sleeves a joint between the first interdental brush body 7 and the second interdental brush body 12. The decorative ring 15 plays roles in decoration and sealing.

In this embodiment, a base 16 is further provided; a base cover 17 is disposed on the base 16; a groove used for accommodating the interdental brush bodies is formed in an upper part of the base cover 17; and a sucking disc 18 is disposed under the base 16. When not in use, the interdental brush bodies may be disposed on the base 16, so that the interdental brush head is prevented from being in contact with another object.

The working principle of this embodiment is further described below.

In this embodiment, the first interdental brush body and the second interdental brush body are detachably connected together into an ivory shape. The first interdental brush body and the second interdental brush body are disposed in such a manner that outer diameters of the first interdental brush body and the second interdental brush body decrease gradually from a rear end to a front end, a diameter of the rear end is so large to be held by hand, and a diameter of the front end is so small to extend the interdental brush into an oral cavity, thereby reducing shielding in the oral cavity during cleaning and shooting. Because the interdental brush bodes are the first interdental brush body and the second interdental brush body that are of a combined structure, and internal assemblies are separately mounted in the two interdental brush bodies, the assemblies can be processed and mounted conveniently. In addition, the assemblies in the two interdental brush bodies are electrically connected to each other through the two contacts, which facilitates circuit detection.

### Embodiment 2

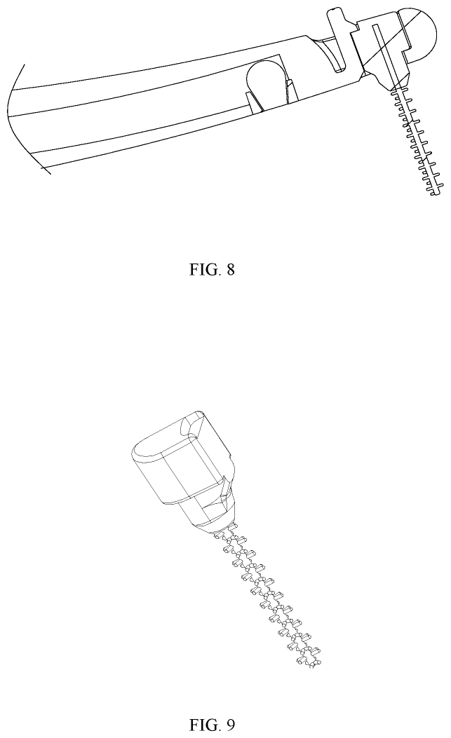

As a preferred embodiment, Embodiment 2 is basically the same as Embodiment 1, and differs from Embodiment 1 in the following: As shown in FIG. 7 to FIG. 9, in this embodiment, a brush head mounting hole penetrating the brush head mounting portion is formed in the brush head mounting portion; an elastic clamping and limiting bar and a fixing and limiting protrusion are oppositely disposed on side surfaces of the brush head mounting hole; the interdental brush head 14 includes a brush head connecting seat and a brush head body; the brush head body is mounted in the brush head connecting seat; a step protrusion matched with the fixing and limiting protrusion is disposed on a side wall at a lower part of the brush head connecting seat; a clamping groove matched with the elastic clamping and limiting bar is disposed at a top of the brush head connecting seat; and side surfaces, opposite to the elastic clamping and limiting bar and the fixing and limiting protrusion, of the brush head connecting seat are a planar structure and a cambered structure, respectively, so that the interdental brush head is detachably mounted on the brush head mounting portion.

Finally, it should be noted that, the above description is only preferred embodiments of the present invention, and is not intended to limit the present invention. Although the present invention is described in detail with reference to the above embodiments, those skilled in the art can still make modifications on the technical solutions described in the above embodiments or make equivalent substitutions on some technical features of the technical solutions. Any modifications, equivalent substitutions, improvements, and the like made within the spirit and principle of the present invention shall be included within the protection scope of the present invention.

1. An interdental brush having an observation function, comprising interdental brush bodies, an interdental brush head (14), as well as a camera (13), a switch button (3), a motherboard (4), a wireless signal transceiver module (5), and a battery (6) that are disposed inside the interdental brush bodies, wherein the interdental brush head (14) is detachably mounted at an end of the interdental brush body; an image acquisition end of the camera (13) is adjacent to the interdental brush head (14); the motherboard (4) is electrically connected to the camera (13), the switch button (3), the wireless signal transceiver module (5), and the battery (6); and the camera (13) sends an acquired image through the wireless signal transceiver module (5) to a terminal having a display screen.

2. The interdental brush having an observation function according to claim 1, wherein the interdental brush bodes comprise a first interdental brush body (7) and a second interdental brush body (12); the first interdental brush body (7) and the second interdental brush body (12) are detachably connected together into an ivory shape; the first interdental brush body (7) is an arc-shaped tubular structure provided with a first accommodating cavity; a first contact mounting seat (8) is disposed at a front end of the first interdental brush body (7); a first contact (9) is disposed on the first contact mounting seat (8); the switch button (3), the motherboard (4), the wireless signal transceiver module (5), and the battery (6) are disposed in the first accommodating cavity; a rear cover (1) is connected to a rear end of the first interdental brush body (7); and the switch button (3) passes through the rear cover (1) and protrudes from an outer surface at a left end of the rear cover (1); and
the second interdental brush body (12) is an arc-shaped tubular structure provided with a second accommodating cavity; a brush head mounting portion used for mounting of the interdental brush head (14) is disposed at a front end of the second interdental brush body (12); a mounting and clamping groove is formed in a rear end of the second interdental brush body (12); a second contact (10) electrically connected to the first contact is disposed in the mounting and clamping groove; a camera mounting hole communicated with the second accommodating cavity is formed in a position that is on a side wall of the second interdental brush body (12) and adjacent to the brush head mounting portion; and the image acquisition end of the camera (13) is disposed in the camera mounting hole.

3. The interdental brush having an observation function according to claim 2, wherein the switch button (3) is electrically connected to the motherboard (4) through a motherboard-switch connecting line (21); the wireless signal transceiver module (5) is electrically connected onto the motherboard (4); the first contact (9) is electrically connected to the motherboard (4) through a first contact connecting line (19); and the second contact (10) is electrically connected to the camera (13) through a camera connecting line (11).

4. The interdental brush having an observation function according to claim 2, wherein a fill light is connected to a side of the camera (13).

5. The interdental brush having an observation function according to claim 2, wherein a USB charging interface (2) is disposed on the rear cover (1); and the USB charging interface (2) is electrically connected to the motherboard (4).

6. The interdental brush having an observation function according to claim 2, being further provided with a decorative ring (15), wherein the decorative ring (15) sleeves a joint between the first interdental brush body (7) and the second interdental brush body (12).

7. The interdental brush having an observation function according to claim 2, wherein a brush head mounting hole (121) is formed inwards in a bottom of the brush head mounting portion; an L-shaped brush head positioning groove (122) is formed in a side wall of the brush head mounting portion; the interdental brush head (14) comprises a brush head body (140) and a brush head connector; the brush head connector comprises a brush head connecting shaft (141) and a brush head positioning protrusion (142); the brush head positioning protrusion (142) is integrally disposed on a side wall of the brush head connecting shaft (141) and is clamped on the L-shaped brush head positioning groove (122); the brush head connecting shaft (141) is matched with the brush head mounting hole (121); the brush head connecting shaft (141) is clamped in the brush head mounting hole (121) through the brush head positioning protrusion (142); and the brush head body (140) is coaxially disposed on the brush head connecting shaft (141).

8. The interdental brush having an observation function according to claim 2, wherein a brush head mounting hole penetrating the brush head mounting portion is formed in the brush head mounting portion; and an elastic clamping and limiting bar and a fixing and limiting protrusion are oppositely disposed on side surfaces of the brush head mounting hole.

9. The interdental brush having an observation function according to claim 1, being further provided with a base (16), wherein a base cover (17) is disposed on the base (16); a groove used for accommodating the interdental brush bodies is formed in an upper part of the base cover (17); and a sucking disc (18) is disposed under the base (16).
